(19) United States
(12) Patent Application Publication
(10) Pub. No.: US 2021/0071321 A1
(43) Pub. Date: Mar. 11, 2021

(54) SHIELDING MATERIAL FABRICATING APPARATUS

(71) Applicant: DAINS Co., Ltd., Jeonju-si (KR)

(72) Inventors: Seung JEONG, Seoul (KR); Chun Seong Park, Suwon-si (KR)

(21) Appl. No.: 16/695,393

(22) Filed: Nov. 26, 2019

(30) Foreign Application Priority Data
Sep. 9, 2019 (KR) 10-2019-0111418

(51) Int. Cl. D01F 9/12; C08J 5/04; B32B 27/12

(52) U.S. Cl. CPC D01F 9/12; D06M 2101/40; B32B 27/12; C08J 5/042

(57) ABSTRACT

A shielding material fabricating apparatus according to the present invention includes: a mixing unit mixing a resin and a carbon fiber; an extrusion unit extruding a mixture obtained in the mixing unit; and a cutting unit cutting an extrudate extruded from the extrusion unit. The shielding material fabricating apparatus according to the present invention is capable of: reducing a manufacturing time and promoting simplification of a process when fabricating an electromagnetic wave shielding material; improving performance in mixing the resin and the carbon fiber, thereby fabricating an electromagnetic wave shielding material having a superior shielding rate; and cutting a metal-plated carbon fiber and simultaneously making the resin impregnated therein without a delay in time, thereby making it possible to use a long fiber as it is in a non-pelletized state.

### CROSS REFERENCE TO RELATED APPLICATION

The present application claims priority to Korean Patent Application No. 10-2019-0111418, filed Sep. 9, 2019, the entire contents of which is incorporated herein for all purposes by this reference.

### BACKGROUND

### 1. Technical Field

The present invention relates to an apparatus for fabricating an electromagnetic wave shielding pellet using a carbon fiber and a resin as materials, and more particularly, to a shielding material fabricating apparatus for in-line processes of cutting the carbon fiber, impregnating the carbon fiber with the resin, extruding the carbon fiber impregnated with the resin, and cutting the carbon fiber impregnated with the resin.

### 2. Description of the Related Art

Conventional shielding cables have been manufactured by braiding or taping processes using metal wires or metal tapes. Such shielding cables have problems of low flexibility and heavy weight due to the use of high density metals. Recently, flexible cable materials are demanded in the automobile industry to shorten an automobile manufacturing process time and improve convenience for workers along with the development of low-cost cables to reduce manufacturing costs. At this point, the development is focused on a reduction in a cable weight, which accounts for about 10 to 15% of the total weight.

Meanwhile, as hybrid vehicles (HV) and hybrid electric vehicles (HEV) are actively developed in line with the de-gasoline trend worldwide, the use of cables for a HV/HEV, which accounts for about 10 to 15% (40 to 45 Kg) of an automobile weight, has increased as much as about two times or more, when compared to that for a vehicle using an internal combustion engine, which accounts for about 5% (20 Kg) of an automobile weight. As the usage amount of cables increases, there is concern about an increase in electromagnetic interference (EMI), which is directly associated with an improvement in fuel efficiency. In order to solve the problem, it is inevitably required to develop a shielding cable that is lighter than the conventional shielding cable.

Especially, it is expected that more advanced shielding will be required when “Ethernet” for high-speed communication is introduced. According to the electronization trend of vehicles, it is foreseen in the related fields that there will be a high possibility of EMI shielding shortage. In addition, due to the application of intelligent safety systems such as high-power electronics and advanced driver assistance systems (ADAS) for increasing drivers' safety and convenience and improving fuel efficiency of vehicles, there is recently a limit with conventional 12V electric systems and the necessity of 48V electric systems is emerging. The increase in usage of electric power results in an increase in an amount of electromagnetic wave emission, which also involves a risk that, for example, malfunction of the electronics may be caused. Thus, the importance of shielding in vehicles is increasing.

The main factors affecting electromagnetic wave shielding performance are complex elements such as a frequency, a length of a material, and a cross-sectional area, and the most important point for expecting a sufficient shielding effect is a low volume specific resistance, that is, a high electrical conductivity of the material.

As electromagnetic wave shielding materials, products obtained by processing carbon fibers and resins for lightness and electrical conductivity are appearing. However, in order to manufacture conventional products, a separate process for pelletizing a carbon fiber is required or a processing process is performed after mixing a carbon fiber that has already been pelletized with a resin, and thereby, there are problems in that the manufacturing time is long and the process is complicated. Furthermore, the resin and the carbon fiber are not uniformly mixed, resulting in another problem of deterioration in shielding performance.

### RELATED ART DOCUMENTS

Patent Document 1: Korean Patent Publication No. 10-1675905 (published on Nov. 8, 2016)
Patent Document 2: Korean Patent Laid-Open Publication No. 10-2018-0067098 (laid-open published on Jun. 20, 2018)

### SUMMARY

An object of the present invention is to provide a shielding material fabricating apparatus capable of reducing a manufacturing time and promoting simplification of a process when fabricating an electromagnetic wave shielding material. Another object of the present invention is to provide a shielding material fabricating apparatus capable of improving performance in mixing a resin and a carbon fiber, thereby fabricating an electromagnetic wave shielding material having a superior shielding rate. In addition, another object of the present invention is to provide a shielding material fabricating apparatus capable of cutting a metal-plated carbon fiber and simultaneously making the resin impregnated therein without a delay in time, thereby making it possible to use a long fiber as it is without having to prepare a pelletized carbon fiber.

According to an exemplary embodiment of the present invention, a shielding material fabricating apparatus includes: a mixing unit mixing a resin and a carbon fiber; an extrusion unit extruding a mixture obtained in the mixing unit; and a cutting unit cutting an extrudate extruded from the extrusion unit.

The mixing unit may include: a first supplier supplying the resin; a second supplier supplying the carbon fiber; and a screw unit mixing the resin and the carbon fiber and transferring the mixture.

The screw unit may include: a first screw cutting the carbon fiber and simultaneously mixing the resin and the carbon fiber; and a second screw transferring the mixture of the carbon fiber that has been cut and the resin.

The second supplier may include a cutter automatically cutting the carbon fiber at a tip thereof.

Some blades of the first screw may be formed as cutting blades for cutting the carbon fiber.

The first screw may include two unit screws provided in parallel to each other, and the cutting blades formed on the two unit screws may be disposed to intersect with each other.

The first screw may include two unit screws provided in parallel to each other, and blades of the two unit screws may have different extension angles from each other.

The resin from the first supplier and the carbon fiber from the second supplier may be supplied simultaneously.

The carbon fiber may be a metal-coated carbon fiber (MCF), and the metal-coated carbon fiber may include two or more different metal-plated layers laminated on the carbon fiber.

### BRIEF DESCRIPTION OF THE DRAWINGS

FIG. 1 is a schematic view of a shielding material fabricating apparatus according to the present invention.

FIG. 2 is a view illustrating a mixing unit including a first supplier and a second supplier in the shielding material fabricating apparatus according to the present invention.

FIG. 3 illustrates a cutter provided in the second supplier of the shielding material fabricating apparatus according to the present invention.

FIG. 4 is an enlarged view of a first screw provided in the mixing unit of the shielding material fabricating apparatus according to the present invention.

FIG. 5 illustrates an aligned state of two unit screws configuring the first screw provided in the mixing unit of the shielding material fabricating apparatus according to the present invention.

FIGS. 6A and 6B illustrate blade-extended angles of the two unit screws configuring the first screw provided in the mixing unit of the shielding material fabricating apparatus according to the present invention.

### DETAILED DESCRIPTION OF THE EMBODIMENTS

Hereinafter, preferred embodiments of the present invention will be described in detail with reference to the accompanying drawings. The advantages and features of the present invention and the methods for accomplishment thereof will be apparent from exemplary embodiments described in detail below together with the accompanying drawings. However, the present invention is not limited to the following exemplary embodiments but may be implemented in variously different forms. The exemplary embodiments may be provided so that the disclosure of the present invention will be thorough and complete, and will fully convey the scope of the invention to those skilled in the art. The present invention is defined only by the scope of the appended claims. The same reference marks throughout the specification denote the same elements.

It is to be understood that although the terms “first”, “second”, and the like may be used herein to describe various materials, elements, components, steps and/or sections, these materials, elements, components, steps and/or sections should not be limited by these terms. These terms are only used to distinguish one material, element, component, step or section from another material, element, component, step or section. Therefore, a first mixture which will be mentioned below may also be a second mixture within the technical spirit of the present invention.

The terms used in the present specification are for explaining the exemplary embodiments rather than limiting the present invention. Unless explicitly described to the contrary, a singular form includes a plural form in the present specification. The terms “comprise” and/or “made of” used in the present specification imply the inclusion of stated materials, components, steps, operations and/or elements without excluding presence or addition of one or more other materials, components, steps, operations and/or elements. Unless otherwise defined, all the terms used in the present specification (including technical or scientific terms) may have the same meanings as commonly understood by those skilled in the art. Further, terms defined in generally used dictionaries may not be interpreted in an idealized or overly formal sense unless expressly defined herein.

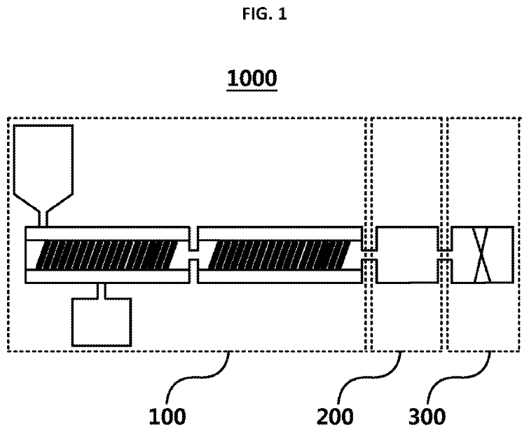

Hereinafter, the present invention will be described in detail with reference to the accompanying drawings. FIG. 1 is a schematic view of a shielding material fabricating apparatus 1000 according to the present invention. As illustrated in FIG. 1, the shielding material fabricating apparatus 1000 according to the present invention includes a mixing unit 100, an extrusion unit 200, and a cutting unit 300.

The mixing unit 100 functions to mix a resin and a carbon fiber. Here, the resin may be a thermoplastic resin, preferably at least one thermoplastic resin selected from the group consisting of a polycarbonate resin, a polystyrene resin, a polyether resin, a polysulfone resin, a polyolefin resin, a polyimide resin, a fluorine resin, a poly(meth)acrylate resin, a polyacetal resin, a polyamide resin, an aromatic vinyl resin, an acrylic-butadiene-styrene copolymer resin, and a polyvinyl chloride resin. More preferably, the resin may be a polypropylene (PP), polyurethane (PU), polyamide6 (PA6), polycarbonate (PC), or acrylonitrile-butadiene-styrene (ABS) resin.

Meanwhile, for the carbon fiber mixed with the resin, a variety of known carbon fibers may be used. The carbon fiber to be used may be commercially purchased, or polyacrylonitrile (PAN)-based or pitch-based manufactured. More preferably, the carbon fiber may be a metal-coated carbon fiber (MCF). The metal-coated carbon fiber may include two or more different metal-plated layers laminated on the carbon fiber.

Specifically, the metal-coated carbon fiber (MCF) may include a first metal-plated layer to a third metal-plated layer, and a metal constituting each metal-plated layer may be nickel (Ni), copper (Cu), titanium (Ti), molybdenum (Mo), aluminum (Al), gold (Au), silver (Ag), or the like. Preferably, the first metal-plated layer may be copper (Cu), the second metal-plated layer may be nickel (Ni), and the third metal-plated layer may be copper (Cu). Each metal-plated layer may be formed on the carbon fiber by various conventional plating methods such as electrolytic plating, electroless plating, and electroplating.

The extrusion unit 200 functions to extrude a mixture obtained in the mixing unit 100 under the conditions of a predetermined temperature and a predetermined number of screw rotations (rpm), and a temperature of an extruder may be subdivided into various sections. For the extrusion unit 200, a variety of conventional extruders may be utilized.

The cutting unit 300 functions to cut an extrudate extruded from the extrusion unit 200. That is, once the resin and the metal-coated carbon fiber (MCF) are extruded out from the extrusion unit 200 after being mixed in the mixing unit 100, the cutting unit 300 cuts the extrudate for pelletization. Pelletized materials are used to manufacture shielding products (such as shielding wires for vehicles) later.

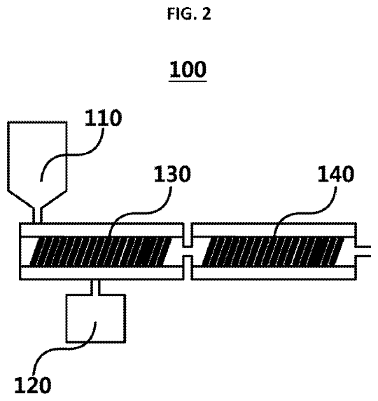

FIG. 2 is a view illustrating a mixing unit including a first supplier and a second supplier in the shielding material fabricating apparatus according to the present invention.

As illustrated in FIG. 2, the mixing unit 100 includes a first supplier 110, a second supplier 120, a screw unit (a first screw 130 and a second screw 140).

Materials are supplied simultaneously from the first supplier 110 and the second supplier 120, and an outlet of the first supplier 110 and an outlet of the second supplier 120 are directed toward the first screw 130. Thus, the materials are mixed by the first screw 130 immediately after being supplied simultaneously.

The first supplier 110 is designed to supply a resin. As mentioned above, the resin may be a thermoplastic resin, preferably at least one thermoplastic resin selected from the group consisting of a polycarbonate resin, a polystyrene resin, a polyether resin, a polysulfone resin, a polyolefin resin, a polyimide resin, a fluorine resin, a poly(meth)acrylate resin, a polyacetal resin, a polyamide resin, an aromatic vinyl resin, an acrylic-butadiene-styrene copolymer resin, and a polyvinyl chloride resin. More preferably, the resin may be a polypropylene (PP), polyurethane (PU), polyamide6 (PA6), polycarbonate (PC), or acrylonitrile-butadiene-styrene (ABS) resin.

The second supplier 120 is designed to supply a carbon fiber. For the carbon fiber, a variety of known carbon fibers may be used. The carbon fiber to be used may be commercially purchased, or polyacrylonitrile (PAN)-based or pitch-based manufactured. More preferably, the carbon fiber may be a metal-coated carbon fiber (MCF). The metal-coated carbon fiber may include two or more different metal-plated layers laminated on the carbon fiber.

Specifically, the metal-coated carbon fiber (MCF) may include a first metal-plated layer to a third metal-plated layer, and a metal constituting each metal-plated layer may be nickel (Ni), copper (Cu), titanium (Ti), molybdenum (Mo), aluminum (Al), gold (Au), silver (Ag), or the like. Preferably, the first metal-plated layer may be copper (Cu), the second metal-plated layer may be nickel (Ni), and the third metal-plated layer may be copper (Cu). Each metal-plated layer may be formed on the carbon fiber by various conventional plating methods such as electrolytic plating, electroless plating, and electroplating.

Since the present invention is configured to have a function to cut the carbon fiber, the carbon fiber supplied from the second supplier 120 may be used as it is in a long state. This will be described in detail below.

The screw unit includes a first screw 130 and a second screw 140 and functions to mix the resin supplied from the first supplier 110 and the carbon fiber (metal-plated carbon fiber) supplied from the second supplier 120 and transfer the mixture to the extrusion unit 200. At this time, the first screw 130 functions to cut the carbon fiber and simultaneously mix the resin and the carbon fiber, and the second screw 140 functions to transfer the mixture to the extrusion unit 200 while continuously mixing the carbon fiber that has been cut and the resin.

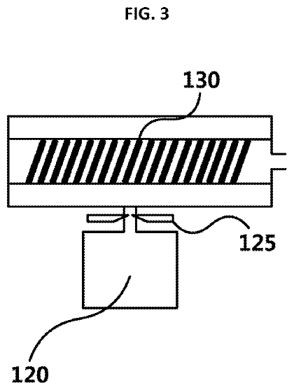

FIG. 3 illustrates a cutter provided in the second supplier of the shielding material fabricating apparatus according to the present invention.

As illustrated in FIG. 3, a cutter 125 for automatically cutting the carbon fiber is provided at a tip of the second supplier 120 supplying the carbon fiber (at a portion adjacent to the first screw 130). When the second supplier 120 pushes the carbon fiber in the long state, the cutter 125 cuts the carbon fiber by operating a cutter blade on a predetermined cycle. For the cutter 125, a variety of conventional cutters may be used, such as a rotary cutter and a reciprocating cutter, and a heater increasing a temperature of the cutter blade may be provided to facilitate cutting.

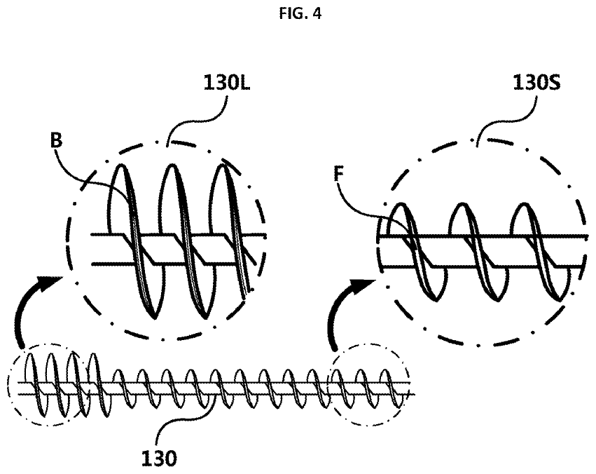

FIG. 4 is an enlarged view of the first screw provided in the mixing unit of the shielding material fabricating apparatus according to the present invention. Some blades of the first screw 130 may be formed as cutting blades 130L for cutting the carbon fiber, and the remaining blades may be formed as flat blades 130S. In another exemplary embodiment, all blades of the first screw 130 may be formed as cutting blades 130L.

The cutting blade 130L is designed to have a sharp tip portion B, whereas the flat blade 130S has a non-sharp tip portion F. The sharp tip portion B of the cutting blade 130L is used to cut the carbon fiber supplied from the second supplier 120. Meanwhile, the cutting blade 130L may be designed to have a larger radius than the flat blade 130S.

The cutter 125 illustrated in FIG. 3 and the cutting blade B illustrated in FIG. 4 may be selectively provided, and both of them may also be provided together. When both of the cutter 125 and the cutting blade B are provided together, it is possible to increase efficiency in cutting the carbon fiber and increase efficiency in mixing the carbon fiber with the resin, thereby improving shielding performance.

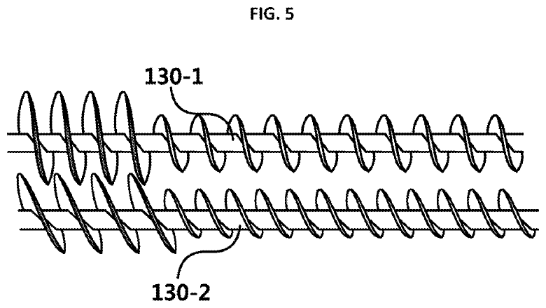

FIG. 5 illustrates an aligned state of two unit screws configuring the first screw provided in the mixing unit of the shielding material fabricating apparatus according to the present invention.

As illustrated in FIG. 5, the first screw 130 may include two unit screws 130-1 and 130-2. The two unit screws 130-1 and 130-2 may be disposed in parallel to each other. Each of the unit screws 130-1 and 130-2 configuring the first screw 130 may also be formed with some blades being cutting blades 130L for cutting the carbon fiber and the remaining blades being flat blades 130S as illustrated in FIG. 4. Of course, all blades of the first screw 130 may be formed as cutting blades 130L.

The cutting blade 130L is designed to have a sharp tip portion B, whereas the flat blade 130S has a non-sharp tip portion F. The sharp tip portion B of the cutting blade 130L may be used to cut the carbon fiber supplied from the second supplier 120, and the cutting blade 130L may be designed to have a larger radius than the flat blade 130S.

The two unit screws 130-1 and 130-2 disposed in parallel to each other may be disposed such that the cutting blades 130L intersect with each other. Since the radius of the cutting blade 130L is larger than that of the flat blade 130S, the flat blades 130S of the two unit screws 130-1 and 130-2 may be spaced apart from each other at a predetermined distance although the cutting blades 130L of the two unit screws 130-1 and 130-2 intersect with each other. When all of the blades of the two unit screws 130-1 and 130-2 are formed as cutting blades 130L, the blades may intersect with each other in the entire blade area. The intersecting cutting blades 130L facilitate the cutting of the carbon fiber, more particularly, a metal-coated carbon fiber.

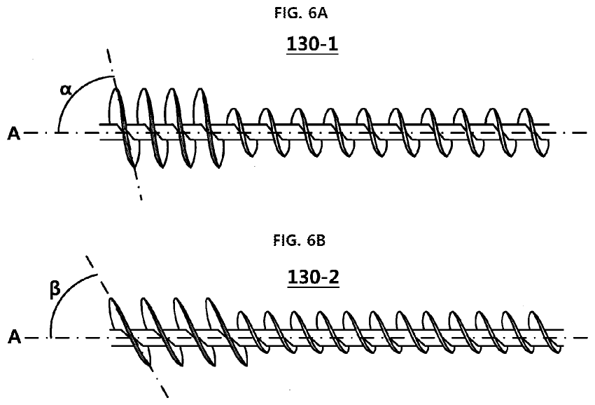

FIGS. 6A and 6B illustrate blade-extended angles of the two unit screws configuring the first screw provided in the mixing unit of the shielding material fabricating apparatus according to the present invention.

The blades of the two unit screws 130-1 and 130-2 configuring the first screw 130 have predetermined extension angles (angles at which the blades are inclined with respect to the horizontal plane). Specifically, the blades are inclined at an angle α with respect to an alignment axis A of the first unit screw 130-1. At this time, since the second unit screw 130-2 is aligned in parallel to the first unit screw 130-1, the second unit screw 130-2 is aligned with the alignment axis A in the same direction as the first unit screw 130-1, while the second unit screw 130-2 is inclined at an angle β with respect to the alignment axis A. Since the blades of the first unit screw 130-1 and the second unit screw 130-2 are inclined at different angles from each other, it is possible to significantly improve the cutting function of the carbon fiber and the mixing function of the resin and carbon fiber.

Meanwhile, the second screw 140 may include only one unit screw, but may include two or more screws like the first screw 130. The second screw 140 may also be formed to have cutting blades to add a cutting function, but may preferably be formed to have flat blades alone when the second screw 140 is used mainly for transferring the mixture that has been subjected to cutting and mixing. The second screw 140 also functions to enhance a mixing ratio of the mixture, and thus, a heater heating the mixture to an appropriate temperature may be connected thereto.

The first screw 130 may rotate in both directions (clockwise and counterclockwise directions) because its main purpose is cutting and mixing. However, the second screw 140 may preferably rotate in one direction (clockwise or counterclockwise direction) because its main purpose is mixing and transferring.

Unlike the conventional art, the present invention is based on division into the first screw, which is mainly for cutting and mixing, and the second screw, which is mainly for mixing and transferring, to improve a mixing ratio of the resin and the metal-coated carbon fiber, thereby improving shielding performance.

The shielding material fabricating apparatus according to the present invention is capable of: reducing a manufacturing time and promoting simplification of a process when fabricating an electromagnetic wave shielding material; improving performance in mixing the resin and the carbon fiber, thereby fabricating an electromagnetic wave shielding material having a superior shielding rate; and cutting the metal-plated carbon fiber and simultaneously making the resin impregnated therein without a delay in time, thereby making it possible to use a long fiber as it is in a non-pelletized state.

Although the exemplary embodiments of the present invention have been described above with reference to the accompanying drawings, it will be understood by those skilled in the art that the present invention may be implemented in other specific forms without changing the technical spirit and the essential features. Therefore, it should be understood that the exemplary embodiments described above are illustrative in all aspects and not restrictive.

What is claimed is:

1. A shielding material fabricating apparatus comprising:
a mixing unit mixing a resin and a carbon fiber;
an extrusion unit extruding a mixture obtained in the mixing unit; and
a cutting unit cutting an extrudate extruded from the extrusion unit.

2. The shielding material fabricating apparatus of claim 1, wherein the mixing unit includes:
a first supplier supplying the resin;
a second supplier supplying the carbon fiber; and
a screw unit mixing the resin and the carbon fiber and transferring the mixture.

3. The shielding material fabricating apparatus of claim 2, wherein the screw unit includes:
a first screw cutting the carbon fiber and simultaneously mixing the resin and the carbon fiber; and
a second screw transferring the mixture of the carbon fiber that has been cut and the resin.

4. The shielding material fabricating apparatus of claim 3, wherein the second supplier includes a cutter automatically cutting the carbon fiber at a tip thereof.

5. The shielding material fabricating apparatus of claim 3, wherein some blades of the first screw are formed as cutting blades for cutting the carbon fiber.

6. The shielding material fabricating apparatus of claim 5, wherein the first screw includes two unit screws provided in parallel to each other, and the cutting blades formed on the two unit screws are disposed to intersect with each other.

7. The shielding material fabricating apparatus of claim 3, wherein the first screw includes two unit screws provided in parallel to each other, and blades of the two unit screws have different extension angles from each other.

8. The shielding material fabricating apparatus of claim 2, wherein the resin from the first supplier and the carbon fiber from the second supplier are supplied simultaneously.

9. The shielding material fabricating apparatus of claim 1, wherein the carbon fiber is a metal-coated carbon fiber (MCF), and the metal-coated carbon fiber includes two or more different metal-plated layers laminated on the carbon fiber.
